(19) United States
(12) Patent Application Publication
(10) Pub. No.: US 2006/0257177 A1
(43) Pub. Date: Nov. 16, 2006

(54) Method and apparatus for adjusting color alignment of image forming device using patterns

(75) Inventors: Jeong-hwan Kim, Gunsan-si (KR); Myung-ho Kyung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/433,399

(22) Filed: May 15, 2006

(30) Foreign Application Priority Data
May 16, 2005 (KR) 2005-0040563

(51) Int. Cl. G03G 15/01

(52) U.S. Cl. 399/301

(57) ABSTRACT

A color alignment adjustment method and apparatus for adjusting the color alignment of a color image forming apparatus by using patterns formed on a middle transfer belt or a photosensitive body of the color image forming apparatus are provided. The color alignment adjustment apparatus includes a sensor which radiates light onto the patterns, detects the amount of light reflected from the patterns, and outputs a signal based on the detection result, a memory which stores pattern information regarding the patterns, a variation detection unit which detects a plurality of portions of the output signal of the sensor that match the pattern information stored in the memory and calculates variations in the locations of a plurality of colors that can be printed by the image forming apparatus based on the locations of the detected portions of the output signal of the sensor and a print location adjustment unit which adjusts the locations of the colors based on the calculated variations.

### CROSS-REFERENCE TO RELATED APPLICATIONS

This application claims the benefit of Korean Patent Application No. 10-2005-0040563, filed on May 16, 2005, in the Korean Intellectual Property Office, the entire disclosure of which is hereby incorporated by reference.

### BACKGROUND OF THE INVENTION

1. Field of the Invention

The present invention relates to a method and apparatus for adjusting the color alignment of a color image forming apparatus so that the locations of different colors printed by the color image forming apparatus are aligned with one another. More particularly, the present invention relates to a color alignment adjustment method and an apparatus for adjusting the color alignment of a color image forming apparatus using a plurality of patterns that are uniform in shape and thus are easily discernible from unintentionally created patterns.

2. Description of the Related Art

Color image forming apparatuses realize a variety of colors by mixing a few basic colors, for example cyan (C), magenta (M), yellow (Y), and black (K). In detail, in order to realize a variety of colors, C, M, Y, and K must be printed at exact locations on a print medium. If C, M, Y, and K are not printed at exact locations on the print medium, target colors may not be properly realized, thus reducing the quality of printing. Therefore, color alignment adjustment by which the locations of C, M, Y, and K are aligned by detecting variations in the locations of C, M, Y, and K is necessary for color image forming apparatuses.

In the case of adjusting color alignment of an electrophotographic image forming apparatus, variations in the locations of C, M, Y, and K are detected by forming a plurality of patterns for C, M, Y, and K on a middle transfer belt of the electrophotographc image forming apparatus and detecting the patterns from the middle transfer belt using a sensor.

FIG. 1A is a diagram of a plurality of patterns formed on a middle transfer belt 100 included in an electrophotographic image forming apparatus for color alignment adjustment. Referring to FIG. 1A, a first pattern 110 for Y, a second pattern 115 for M, a third pattern 120 for C, and a fourth pattern 125 for K are formed on the middle transfer belt 100 along a sub-scanning direction and separated by regular intervals. In addition, the first, second, third, and fourth patterns 110, 115, 120, and 125 must be formed on the middle transfer belt 100 so that the distance between a pair of points 130 and 135 of the first pattern 110 on a straight line parallel to the sub-scanning direction, the distance between a corresponding pair of points 140 and 145 of the second pattern 115, the distance between a corresponding pair of points 150 and 155 of the third pattern 120, and the distance between a corresponding pair of points 160 and 165 of the fourth pattern 125 are identical to a desired distance.

FIG. 1B is a graph illustrating the variation of the magnitude of an output signal of a sensor 105 of FIG. 1A that depends on the location of the sensor 105 with respect to the middle transfer belt 100. The output signal of the sensor 105 is generated by radiating light onto the middle transfer belt 100 and sensing the amount of light reflected from the middle transfer belt 100. Referring to FIG. 1B, the output signal of the sensor 105 has a high amplitude whenever the sensor 105 detects a pattern formed on the middle transfer belt 100.

FIG. 1C is a graph illustrating a digitalized output signal of the sensor 105 of FIG. 1A. Referring to FIG. 1C, the digitalized output signal of the sensor 105 has a value of 1 when the sensor 105 detects a pattern formed on the middle transfer belt 100. Therefore, a distance between the first pattern 110 and the second pattern 115 formed on the middle transfer belt 100 can be calculated by multiplying the velocity of the middle transfer belt 100 by a difference between a first time t₁ when the digitalized output signal of the sensor 105 has a value of 1 and a third time t₃ when the digitalized output signal has a value of 1.

A difference between the calculated distance and a desired distance between the first pattern 100 and the second pattern 115 is a variation in the distance between Y and M in the sub-scanning direction. In this manner, variations in the locations of C, M, Y, and K in the sub-scanning direction can be calculated from the differences between the first, third, fifth, and seventh times t₁, t₃, t₅, and t₇ when the digitalized output signal of the sensor 105 has a value of 1.

A distance in the sub-scanning direction between the points 130 and 135of the first pattern 110 is calculated by multiplying the difference between the first time t₁ and the second time t₂ when the digitalized output signal of the sensor 105 has a value of 1 by the velocity of the middle transfer belt 100. Accordingly, it is possible to determine the degree to which the first pattern 110 for Y is deviated from its desired location in the main scanning direction based on a difference between the desired distance and the calculated distance. In this manner, it is possible to determine the degree to which the second, third, and fourth patterns 115, 120, and 125 for M, C, and K, respectively, are deviated from their respective desired locations in the main scanning direction.

Thereafter, the locations of Y, M, C, and K are adjusted based on the variations in the distances between the first, second, third, and fourth patterns 110, 115, 120, and 125 in the vertical and main scanning directions so that they are aligned with one another.

FIG. 2A illustrates a plurality of patterns 110, 115, 120, and 125 for C, M, Y, and K formed on a middle transfer belt 100 which has a damaged portion 200 and is polluted with a toner stain 210. Referring to FIG. 2A, a sensor 105 senses the middle transfer belt 100 and outputs a signal. The waveform of the output signal of the sensor 105 of FIG. 2A is illustrated in FIG. 2B. Referring to FIG. 2B, peaks 220 and 230 of the output signal of the sensor 105 correspond to the detection of the damaged portion 200 and the toner stain 210. FIG. 2C illustrates the waveform of a digitalized output signal of the sensor 105 of FIG. 2A. Referring to FIG. 2C, values 240, 250, 260, and 270 of 1 are detected from the digitalized output signal of the sensor 105 of FIG. 2A at times between tₐ and t_{b} in accordance with the detection of the damaged portion 200 and the toner stain 210. In other words, the digitalized output signal of the sensor 105 of FIG. 2A is detected to have a value of 1 when the sensor 105 of FIG. 2A detects the damaged portion 200 or the toner stain 210.

In short, in the above-described conventional color alignment adjustment method using patterns, the sensor 105 of FIG. 1A or 2A may mistakenly detect the damaged portion 200 of the middle transfer belt 100 or the toner stain 210 on the middle transfer belt 100 as a pattern, thereby providing incorrect information regarding variations in the locations of Y, M, C, and K.

Accordingly, there is a need for an improved method and apparatus for adjusting color alignment of an image forming device.

### SUMMARY OF THE INVENTION

Exemplary embodiments of the present invention provide a method and apparatus for adjusting color alignment by using a plurality of patterns that are uniform in shape and thus are easily discernible from unintentionally created patterns.

According to an exemplary aspect of the present invention, there is provided a color alignment adjustment apparatus that detects a plurality of patterns produced by an image forming apparatus, which prints in colors, and adjusts the color alignment of the image forming apparatus based on the detection results. The color alignment adjustment apparatus comprises a sensor which radiates light onto the patterns, detects the amount of light reflected from the patterns, and outputs a signal based on the detection result, a memory which stores pattern information regarding the patterns, a variation detection unit which detects a plurality of portions of the output signal of the sensor that match the pattern information stored in the memory and calculates variations in the locations of a plurality of colors that can be printed by the image forming apparatus based on the locations of the detected portions of the output signal of the sensor and a print location adjustment unit which adjusts the locations of the colors based on the calculated variations.

The image forming apparatus may be an electrophotographic image forming apparatus.

The patterns may be formed on a middle transfer belt of the image forming apparatus.

The patterns may be formed on a photosensitive body of the image forming apparatus.

The memory may store pattern information regarding each of the colors.

The memory may store separate pattern information for each of the colors.

The pattern information stored in the memory may be a combination of at least one 0 and at least one 1.

The variation detection unit may detect a portion of the output signal of the sensor that matches the combination of at least one 0 and at least one 1 stored in the memory.

The variation detection unit may comprise an analog-to-digital (A/D) converter which converts the output signal of the sensor into a digital signal, a comparator which reads the combination of at least 0s and at least 1s from the memory and detects a plurality of portions of the digital signal that match with the read combination of at least one 0 and at least one 1, and a calculator which calculates variations in the locations of the colors based on the locations of the detected portions.

The pattern information stored in the memory may comprise a plurality of combinations of at least 0s and at least 1s and time interval information regarding time intervals between the combinations of at least one 0 and at least one 1.

According to another exemplary aspect of the present invention, there is provided a color alignment adjustment method in which a plurality of patterns produced by an image forming apparatus, which prints in colors, are detected and the color alignment of the image forming apparatus is adjusted based on the detection results. The color alignment adjustment method comprises radiating light onto the patterns, detecting the amount of light reflected from the patterns, and outputting a signal based on the detection result by using a sensor, reading pattern information regarding the patterns from a memory and detecting a plurality of portions of the output signal that match the read pattern information, calculating variations in the locations of a plurality of patterns of colors that can be printed by the image forming apparatus based on the locations of the detected portions of the output signal and adjusting the locations of the colors based on the calculated variations.

The image forming apparatus may be an electrophotographic image forming apparatus.

The patterns may be formed on a middle transfer belt of the image forming apparatus.

The patterns may be formed on a photosensitive body of the image forming apparatus.

The memory may store pattern information regarding each of the colors.

The memory may store separate pattern information for each of the color.

The pattern information stored in the memory may be a combination of at least one 0 and at least one 1.

The detecting may comprise detecting a portion of the output signal that matches the combination of at least one 0 and at least one 1 stored in the memory.

The detecting may comprise: converting the output signal into a digital signal; detecting a plurality of portions of the digital signal that match the combination of at least one 0 and at least one 1 and calculating variations in the locations of the patterns of colors based on the locations of the detected portions.

The pattern information stored in the memory may comprise a plurality of combinations of at least one 0 and at least one 1 and time interval information regarding time intervals between the combinations of at least one 0 and at least one 1.

According to another exemplary aspect of the present invention, there is provided a computer-readable recording medium storing a computer program for executing the color alignment adjustment method.

### BRIEF DESCRIPTION OF THE DRAWINGS

The above and other object, features and advantages of the present invention will become more apparent by describing in detail exemplary embodiments thereof with reference to the attached drawings in which:

FIGS. 1A, 1B, and 1C are diagrams illustrating a conventional color alignment adjustment method using patterns formed on a middle transfer belt;

FIGS. 2A, 2B, and 2C are diagrams illustrating the problems with the conventional color adjustment method when the middle transfer belt has a damaged portion or is polluted with a toner stain;

FIG. 3 is a diagram of a plurality of patterns used for color alignment adjustment according to an exemplary embodiment of the present invention;

FIG. 4 is a diagram illustrating a digitalized signal output by a sensor of FIG. 3 as a result of sensing a pattern formed on a middle transfer belt;

FIG. 5 is a diagram illustrating a digitalized signal output by the sensor of FIG. 3 as a result of sensing patterns formed on a middle transfer belt with a damaged portion;

FIG. 6 is a block diagram of a color alignment adjustment apparatus using patterns according to an exemplary embodiment of the present invention;

FIG. 7 is a detailed block diagram of a variation detection unit of FIG. 6;

FIG. 8 is a flowchart illustrating a color alignment adjustment method using patterns according to an exemplary embodiment of the present invention;

FIG. 9 is a diagram of a pattern used for color alignment adjustment according to another exemplary embodiment of the present invention;

FIG. 10A is a diagram of a pattern used for color alignment adjustment according to another exemplary embodiment of the present invention;

FIG. 10B is a diagram of a pattern used for color alignment adjustment according to another exemplary embodiment of the present invention;

FIG. 11A is a diagram of a plurality of patterns used for color alignment adjustment according to another exemplary embodiment of the present invention; and

FIG. 11B is a diagram of a plurality of patterns used for color alignment adjustment according to another exemplary embodiment of the present invention.

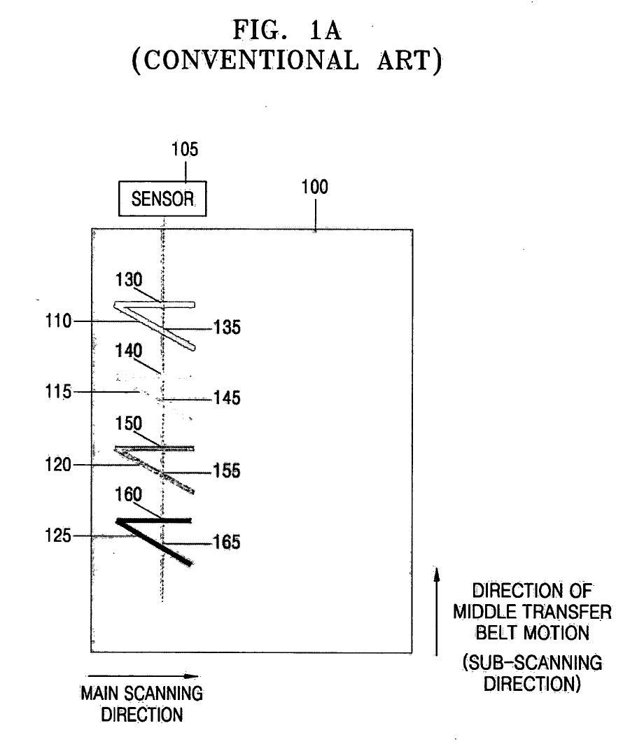

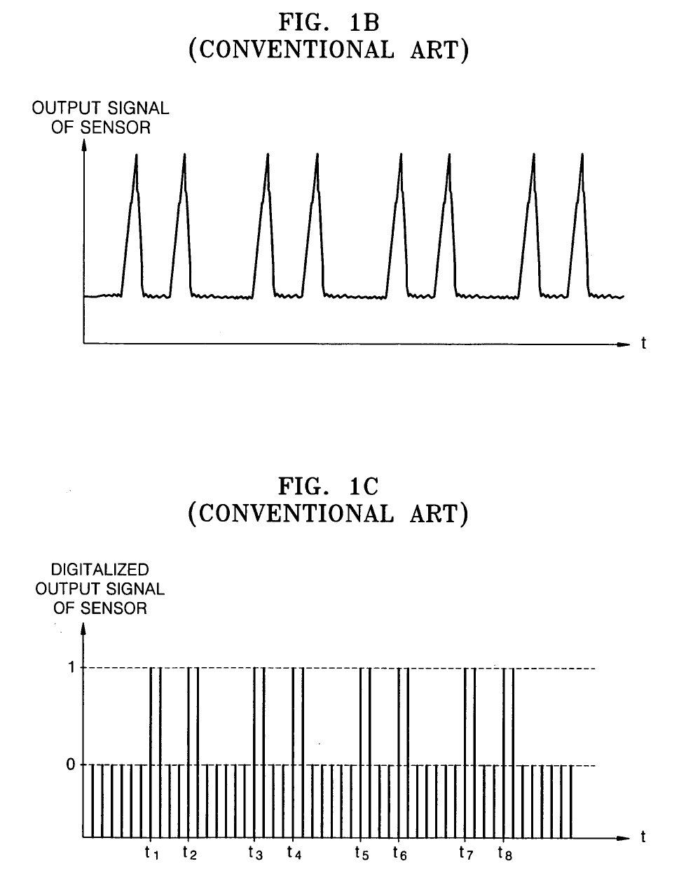

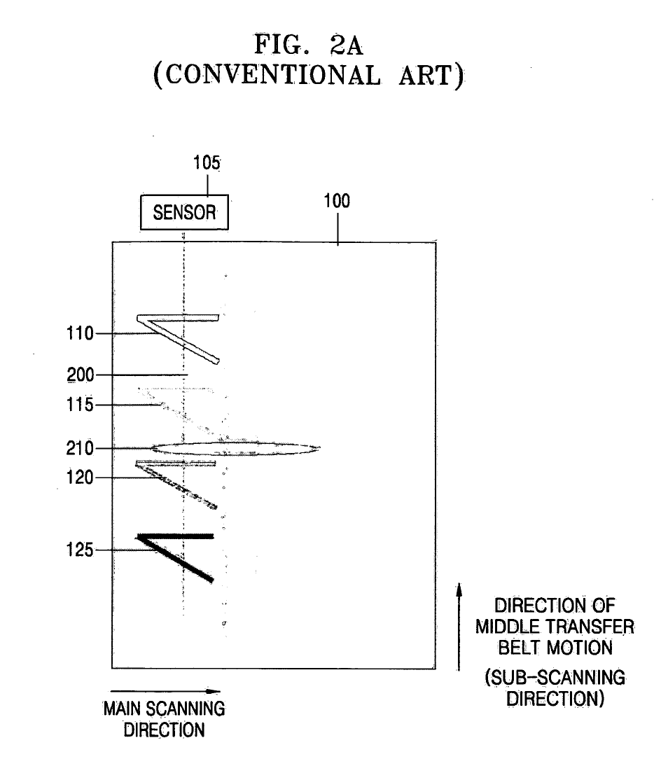

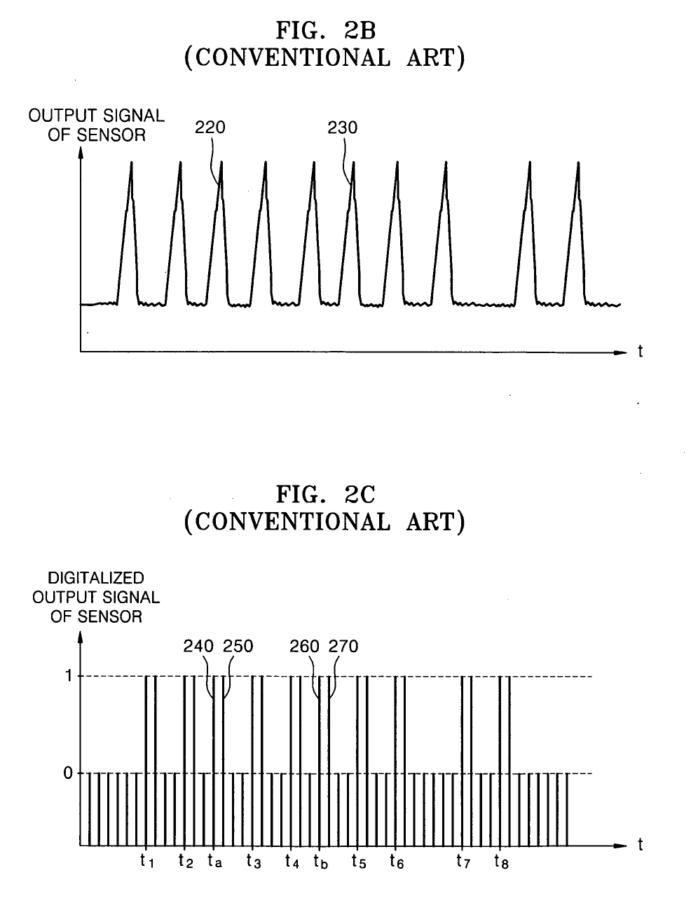

Throughout the drawings, the same drawing reference numerals will be understood to refer to the same elements, features, and structures.

### DETAILED DESCRIPTION OF EXEMPLARY EMBODIMENTS

The present invention will now be described more fully with reference to the accompanying drawings in which exemplary embodiments of the invention are shown. The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

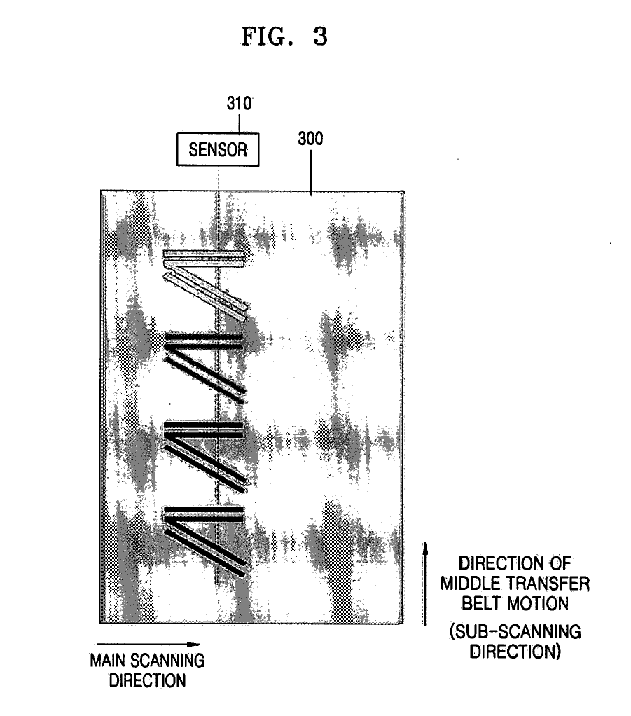

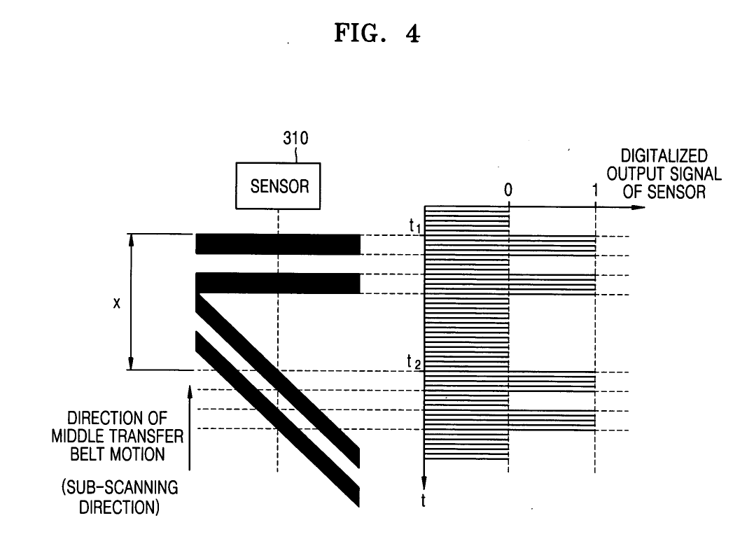

FIG. 3 is a diagram of a plurality of patterns used for color alignment adjustment according to an exemplary embodiment of the present invention. Referring to FIG. 3, the patterns are formed on a middle transfer belt 300 for color alignment adjustment and separated from one another by regular intervals. FIG. 4 is a graph illustrating a digitalized output signal of a sensor 310 that senses a pattern for magenta (M) formed on the middle transfer belt 300. The digitalized output signal of the sensor 310 is generated by radiating light onto the middle transfer belt 300, detecting the amount of light reflected from the middle transfer belt 300 to generate an output signal of the sensor 310 and digitalizing the output signal of the sensor 310.

An exemplary method of detecting the location of the pattern for M formed on the middle transfer pattern 300 by using the sensor 310 will now be described. Pattern information is stored in a memory (not shown) of a color alignment adjustment apparatus and may be stored in advance. The stored information is used to specify that a digitalized signal output by the sensor 310 is detected as, for example, two iterations of ‘0011111001111100’ when the sensor 310 detects the pattern for M formed on the middle transfer belt 300. Then, if the digitalized output signal of the sensor 310 matches the pattern information stored in the memory, it is determined that the sensor 310 has detected the pattern for M from the middle transfer belt 300.

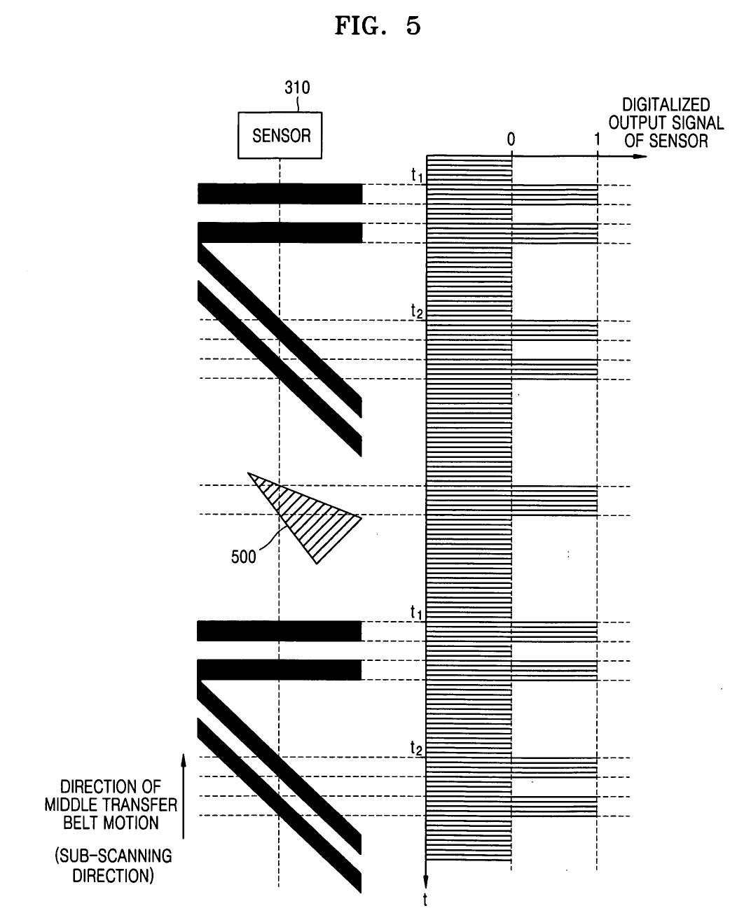

FIG. 5 is a graph illustrating a digitalized output signal of the sensor 310 when sensing a middle transfer belt 300 with a damaged portion 500. Referring to FIG. 5, a portion of a digitalized output signal of the sensor 310 corresponding to the damaged portion 500 has a different pattern than that indicated by the information stored in the memory of the color alignment adjustment apparatus and thus is disregarded when detecting the locations of the patterns of FIG. 3. Therefore, the detection of the damaged portion 500 or a toner stain that may be unwashed from the middle transfer belt 300 is easily discernible from the detection of a pattern, and thus does not affect color alignment adjustment using patterns.

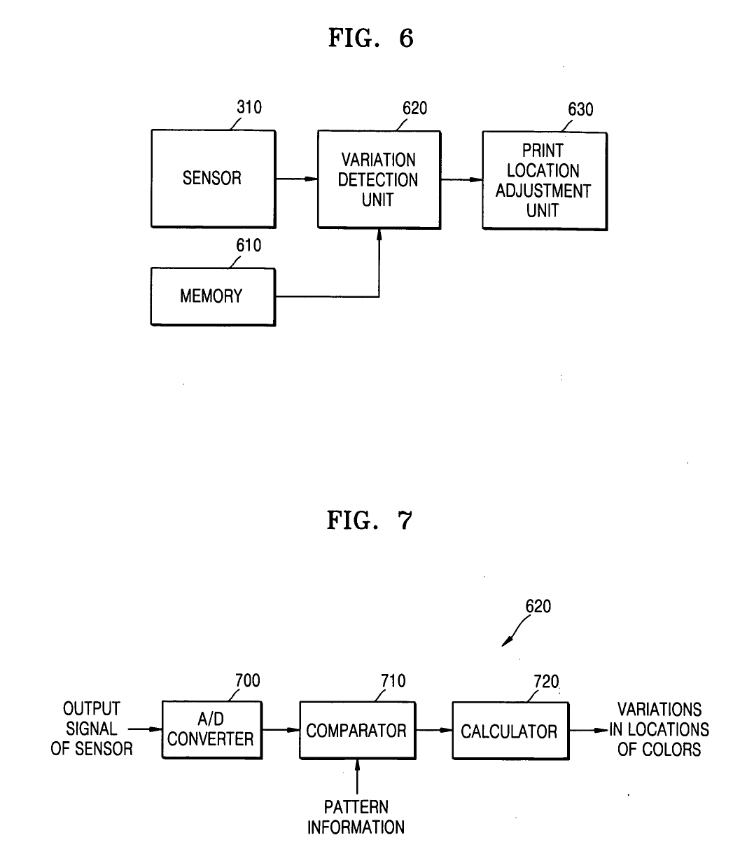

FIG. 6 is a block diagram of a color alignment adjustment apparatus using patterns according to an exemplary embodiment of the present invention. Referring to FIG. 6, the color alignment adjustment apparatus comprises a sensor 310, a memory 610, a variation detection unit 620, and a print location adjustment unit 630.

Pattern information regarding a plurality of patterns to be formed on a middle transfer belt 300 may be stored in the memory 610 in advance. Assuming that patterns which look like those illustrated in FIGS. 3 and 4 are to be formed on the middle transfer belt 300, the pattern information may be set as two iterations of ‘00111110001111100’ or may be set as two iterations of another combination of 0s and 1s in which ‘0011’ is sequentially followed by any two values, ‘1001’, any four values, and a series of 0s. However, the pattern information may be set as a combination of 0s and 1s other than the one set forth herein as long as it can make a portion of the digital output signal of the sensor 310 corresponding to each of the patterns discernible from a portion of the digital output signal of the sensor corresponding to, for example, a damaged portion of the middle transfer belt 300 or a toner stain on the middle transfer belt 300. For example, the pattern information may be set in the memory 610 as ‘001111100011111000000000000000111110001111100’.

A plurality of patterns satisfying the pattern information stored in the memory 610 are formed in different colors on the middle transfer belt 300. Thereafter, the middle transfer belt 300 on which the patterns satisfying the pattern information stored in the memory 610 are formed is moved below the sensor 310, and the sensor 310 radiates light onto the middle transfer belt 300, senses the amount of light reflected from the middle transfer belt 300, and outputs a signal based on the sensed results. The variation detection unit 620 compares the output signal of the sensor 310 with the pattern information stored in the memory 610, detects portions of the output signal of the sensor 310 that match the pattern information stored in the memory 610, determines the detected portions of the output signal of the sensor 310 as corresponding to the patterns formed on the middle transfer belt 300, and calculates variations in the distances between the patterns formed on the middle transfer belt 300 based on the determination results.

The print location adjustment unit 630 adjusts the locations of the colors of the patterns formed on the middle transfer belt 300 based on the calculated results provided by the variation detection unit 620 so that the corresponding colors are aligned with one another.

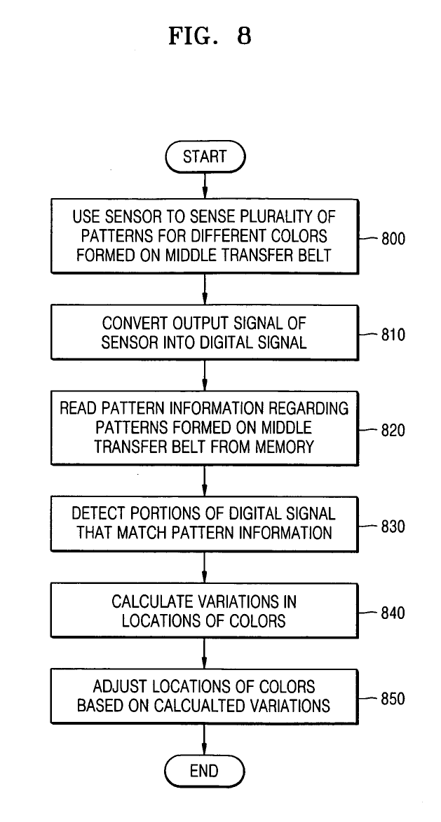

FIG. 7 is a detailed block diagram of the variation detection unit 620 of FIG. 6. Referring to FIG. 7, the variation detection unit 620 includes an analog-to-digital (A/D) converter 700, a comparator 710, and a calculator 720. The operation of the variation detection unit 620 will now be described in detail with reference to FIG. 8, which is a flowchart illustrating a color alignment adjustment method using patterns according to an exemplary embodiment of the present invention.

Referring to FIGS. 7 and 8, in operation 800, the sensor 310 senses a plurality of patterns formed in different colors, in other words Y, M, C, and K, on the middle transfer belt 300 and outputs an analog signal as the detection result. In operation 810, the A/D converter 700 converts the analog signal output by the sensor 310 into a digital signal. If the sensor 310 is able to output a digital signal instead of an analog signal as the detection result, the variation detection unit 620 may not include the A/D converter 700.

In operation 820, the comparator 710 reads pattern information from the memory 610. In operation 830, the comparator 710 compares the read pattern information with the digitalized output signal of the sensor 310 provided by the A/D converter 700 and detects portions of the digitalized output signal of the sensor 310 that match with the read pattern information. For example, if the pattern information is set in the memory 610 as two iterations of ‘00111110001111100’, a series of signal values that matches the pattern information set in the memory 610 is detected from the digitalized output signal of the sensor 310 as a portion corresponding to one of the patterns for Y, M, C, and K formed on the middle transfer belt 300. In this manner, in operation 830, the locations of the patterns for Y, M, C, and K formed on the middle transfer belt 300 are detected.

In operation 840, the calculator 720 calculates variations in the locations of Y, M, C, and K in a sub-scanning direction and in a main-scanning direction based on the detected locations of the patterns for Y, M, C, and K formed on the middle transfer belt 300.

The calculation of the variations in the locations of Y, M, C, and K in the sub-scanning direction by the calculator 720 will now be described in further detail. A first time when a value of 1 is detected from each of the detected portions of the digitalized output signal of the sensor 310, and differences between the detected first times is multiplied by the velocity of the middle transfer belt 300, thereby obtaining the distances between the patterns for Y, M, C, and K formed on the middle transfer belt 300. Differences between desired distances between the patterns for Y, M, C, and K and the measured distances between the patterns for Y, M, C, and K are variations in the locations of Y, M, C, and K.

For example, if a value of 1 is detected from a portion of the digitalized output signal of the sensor 310 corresponding to the pattern for Y at 0.4 seconds, a value of 1 is detected from a portion of the digitalized output signal of the sensor 310 corresponding to the pattern for M at 1.4 seconds and the velocity of the middle transfer belt 300 is 50 cm/sec, the pattern for Y and the pattern M are separated by 50 cm. If the pattern for Y and the pattern M are supposed to be separated by 49.8 cm, Y and M are misaligned relative to each other by 2 mm (=50 cm−49.8 cm). In this case, if Y and M are to be printed on the same spot on a print medium, they will be offset by 2 mm, thus making it difficult to properly represent a target color.

The calculation of the variations in the locations of Y, M, C, and K in the main scanning direction by the calculator 720 will now be described in further detail. The calculator 720 detects the first and third times that a value of 1 is detected from each of the portions of the digitalized output signal of the sensor corresponding to the patterns for Y, M, C, and K, i.e., t₁ and t₂ shown in FIG. 4. An internal distance x of each of the patterns for Y, M, C, and K is calculated by multiplying a difference between t₁ and t₂ by the velocity of the middle transfer belt 300. Variations in the locations of Y, M, C, and K in the main scanning direction are calculated based on differences between the calculated internal distances between portions of the patterns for Y, M, C, and K and a desired internal distance between portions of the patterns for Y, M, C, and K. The calculated internal distances between portions of the patterns for Y, M, C, and K vary according to the locations of the respective patterns in the main scanning direction. The variations in the locations of Y, M, C, and K in the main scanning direction are proportional to the calculated internal distances between the portions of the respective patterns. Thus, the variations in the locations of Y, M, C, and K in the main scanning direction can be calculated from the calculated internal distances between the portions of the respective patterns.

In operation 850, the print location adjustment unit 630 receives the print location variations of Y, M, C, and K in the sub-scanning direction and in the main scanning direction from the calculator 720 and adjusts the print locations of Y, M, C, and K with reference to the received print location variations to align the print locations of Y, M, C, and K.

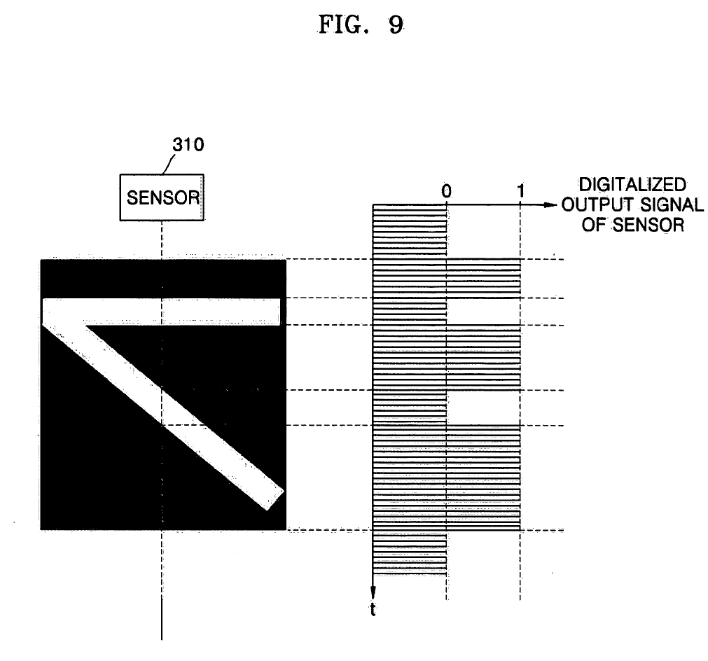

FIG. 9 is a diagram of a pattern used for color alignment adjustment according to another exemplary embodiment of the present invention. Referring to FIG. 9, the patterns may be described by pattern information as a combination of 0s and 1s in which ‘01’ is sequentially followed by six unknown signal values, ‘100001’ and ‘10000001’. The pattern information may be stored in the memory 610 of FIG. 6. The pattern information for the patterns of FIG. 9 may also be set in the memory 610 of FIG. 6 as a combination of 0s and 1s other than the combination set forth herein or as a combination of time information regarding times a predetermined signal value is detected.

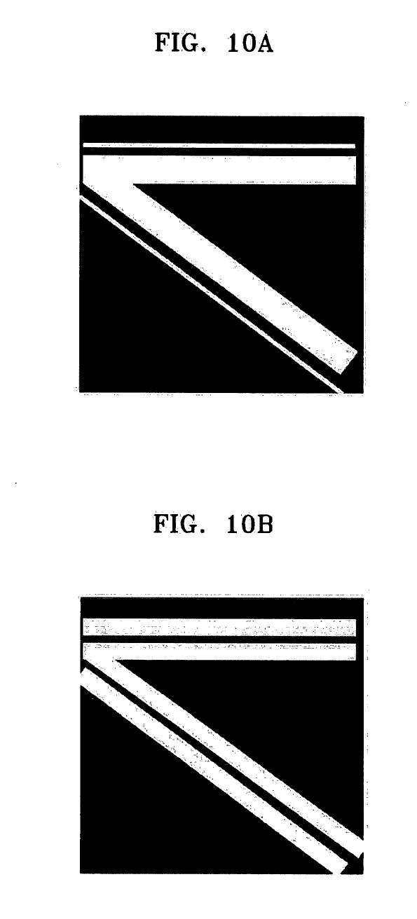

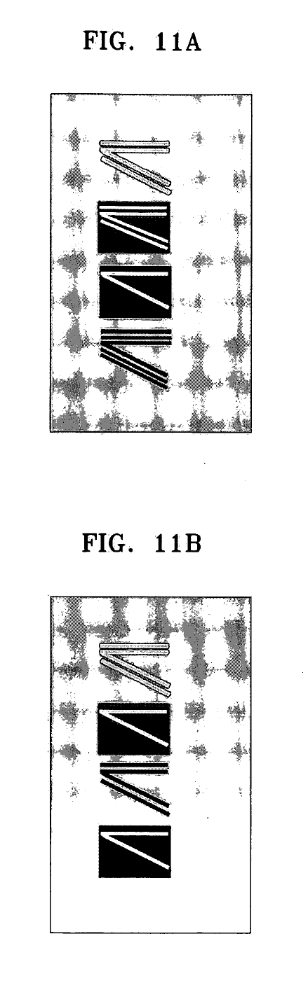

FIGS. 10A and 10B are diagrams of patterns used for color alignment adjustment according to another exemplary embodiment of the present invention, and FIGS. 11A and 11B are diagrams of patterns used for color alignment adjustment according to another exemplary embodiment of the present invention.

Referring to FIGS. 11A and 11B, the patterns, which correspond to different colors, in other words Y, M, C, and K, are different from one another, and thus, they are easily discernible from one another and from, for example, a damaged portion of the middle transfer belt 300 on which they are formed or a toner stain on the middle transfer belt 300. Accordingly, the memory 610 of FIG. 6 must store different pattern information specifying the different colors and shapes of the patterns.

In the color alignment adjustment method using patterns according to an exemplary embodiment of the present invention, a plurality of patterns are formed on a middle transfer belt included in an electrophotographic image forming apparatus. However, the patterns may be formed on a photosensitive body, such as an organic photosensitive body, and then color alignment adjustment may be carried out using the patterns formed on the photosensitive body. In addition, in a case where the color alignment adjustment method using patterns according to an exemplary embodiment of the present invention is applied to a thermal transfer image forming apparatus or an inkjet image forming apparatus, the patterns may be formed on a medium, and then color alignment adjustment may be carried out by detecting the patterns from the medium.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet).

As described above, according to the exemplary embodiments of the present invention, a plurality of patterns of a plurality of colors, which are uniform in shape and thus are easily discernible from dirt or a damaged portion on a middle transfer belt, are formed on the middle transfer belt. Thereafter, variations in the locations of the patterns are detected by sensing the patterns formed on the middle transfer belt using a sensor. Therefore, even when the middle transfer belt has a damaged portion or a toner stain, it is possible to precisely detect the patterns from the middle transfer belt by using the sensor, and thus, it is possible to precisely adjust color alignment of an image forming apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A color alignment adjustment apparatus that detects a plurality of patterns produced by an image forming apparatus and adjusts the color alignment of the image forming apparatus based on the detection results, the color alignment adjustment apparatus comprising:
a sensor which radiates light onto the patterns, detects the amount of light reflected from the patterns, and outputs a signal based on the detection result;
a memory which stores pattern information regarding the patterns;
a variation detection unit which detects a plurality of portions of the output signal of the sensor that match the pattern information stored in the memory and calculates variations in the locations of a plurality of colors that can be printed by the image forming apparatus based on the locations of the detected portions of the output signal of the sensor; and
a print location adjustment unit which adjusts the locations of the colors based on the calculated variations.

2. The color alignment adjustment apparatus of claim 1, wherein the image forming apparatus is an electrophotographic image forming apparatus.

3. The color alignment adjustment apparatus of claim 2, wherein the patterns are formed on a middle transfer belt of the image forming apparatus.

4. The color alignment adjustment apparatus of claim 2, wherein the patterns are formed on a photosensitive body of the image forming apparatus.

5. The color alignment adjustment apparatus of claim 1, wherein the memory stores pattern information regarding each of the colors.

6. The color alignment adjustment apparatus of claim 5, wherein the memory stores separate pattern information for each of the colors.

7. The color alignment adjustment apparatus of claim 1, wherein the pattern information stored in the memory is a combination of at least one 0 and at least one 1.

8. The color alignment adjustment apparatus of claim 7, wherein the variation detection unit detects a portion of the output signal of the sensor that matches the combination of at least one 0 and at least one 1 stored in the memory.

9. The color alignment adjustment apparatus of claim 7, wherein the variation detection unit comprises:
an analog-to-digital (A/D) converter which converts the output signal of the sensor into a digital signal;
a comparator which reads the combination of at least 0s and at least 1s from the memory and detects a plurality of portions of the digital signal that match with the read combination of at least one 0 and at least one 1; and
a calculator which calculates variations in the locations of the colors based on the locations of the detected portions.

10. The color alignment adjustment apparatus of claim 1, wherein the pattern information stored in the memory comprises a plurality of combinations of at least 0s and at least 1s and time interval information regarding time intervals between the combinations of at least one 0 and at least one 1.

11. A color alignment adjustment method in which a plurality of patterns produced by an image forming apparatus are detected and the color alignment of the image forming apparatus is adjusted based on the detection results, the color alignment adjustment method comprising:
radiating light onto the patterns, detecting the amount of light reflected from the patterns by using a sensor, and outputting a signal based on the detection result;
reading pattern information regarding the patterns from a memory and detecting a plurality of portions of the output signal that match the read pattern information;
calculating variations in locations of a plurality of patterns of colors that can be printed by the image forming apparatus based on locations of the detected portions of the output signal; and
adjusting locations of the colors based on the calculated variations.

12. The color alignment adjustment method of claim 11, wherein the image forming apparatus is an electrophotographic image forming apparatus.

13. The color alignment adjustment method of claim 12, wherein the patterns are formed on a middle transfer belt of the image forming apparatus.

14. The color alignment adjustment method of claim 12, wherein the patterns are formed on a photosensitive body of the image forming apparatus.

15. The color alignment adjustment method of claim 11, wherein the memory stores pattern information regarding at least one color.

16. The color alignment adjustment method of claim 15, wherein the memory stores separate pattern information for each color.

17. The color alignment adjustment method of claim 11, wherein the pattern information stored in the memory is a combination of at least one 0 and at least one 1.

18. The color alignment adjustment method of claim 17, wherein the detecting comprises detecting a portion of the output signal that matches the combination of at least one 0 and at least one 1 stored in the memory.

19. The color alignment adjustment method of claim 17, wherein the detecting comprises:
converting the output signal into a digital signal;
detecting a plurality of portions of the digital signal that match the combination of at least one 0 and at least one 1; and
calculating variations in locations of the patterns of colors based on locations of the detected portions.

20. The color alignment adjustment method of claim 11, wherein the pattern information stored in the memory comprises a plurality of combinations of at least one 0 and at least one 1 and time interval information regarding time intervals between the combinations of at least one 0 and at least one 1.

21. A computer-readable recording medium storing a computer program for executing the color alignment adjustment method of claim 11.
